(19) United States
(12) Patent Application Publication
(10) Pub. No.: US 2017/0124898 A1
(43) Pub. Date: May 4, 2017

(54) Music Synchronization System And Associated Methods

(71) Applicant: Optek Music Systems, Inc., Reno, NV (US)

(72) Inventor: John Rusty Shaffer, Reno, NV (US)

(73) Assignee: Optek Music Systems, Inc., Reno, NV (US)

(21) Appl. No.: 15/343,619

(22) Filed: Nov. 4, 2016

Related U.S. Application Data
(60) Provisional application No. 62/250,836, filed on Nov. 4, 2015.

(51) Int. Cl. G09B 15/02; G09B 15/04; G06F 17/30

(52) U.S. Cl. CPC G09B 15/023; G06F 17/30761; G09B 15/04; G10H 2220/091; G10H 2210/385

(57) ABSTRACT

Exemplary embodiments are directed to music synchronization systems including an electronic artist audio database with a plurality of artist audio files and an electronic data database including a plurality of data files corresponding to the respective plurality of artist audio files. Each of the data files includes data relating to fingering positions for an instrument. The systems include a processing device configured to execute a synchronization engine that receives as input an artist audio file from the electronic artist audio database and a corresponding data file from the electronic data database, and outputs via a graphical user interface a synchronized music lesson for the artist audio file. Exemplary embodiments are also directed to methods of music synchronization.

### CROSS-REFERENCE TO RELATED APPLICATIONS

The present application claims the priority benefit of U.S. Provisional Application Ser. No. 62/250,836, filed Nov. 4, 2015, which is hereby incorporated by reference in its entirety.

### TECHNICAL FIELD

The present disclosure relates to music synchronization systems and associated methods and, in particular, to music synchronization systems that synchronize music and data files to provide an improved music lesson to a user.

### BACKGROUND

Virtual music lessons are provided for a variety of instruments. In general, to access the virtual music lesson, a user plays the song of interest through one software or webpage and accesses the music lesson through a separate software or webpage, thereby involving switching multiple screens to play, stop and rewind the music lesson. In some instances, music lessons are provided in a single software or webpage with the audio file being in the form of a musical instrument digital interface (MIDI) file. Thus, the audio file, being in a MIDI format, does not sound like the artist audio recording. Further, artist audio recordings can be in the form of “studio” or “live” performances which can differ substantially, such as Led Zeppelin's “Whole Lotta Love” from the artist audio studio recording, entitled “Led Zeppelin 11” and from the artist audio live recording, entitled “The Song Remains the Same.” In general, virtual music lessons correspond to studio performances and do not provide lessons corresponding to the unique live performance.

As used herein, the term “artist audio” (e.g., studio audio or live audio) and related terms, is a reference to an audio file that is not a MIDI file, but a reference to live or studio artist sound recording. A MIDI file is a purely non-artist, imperfect emulation of artist audio, whereas “artist audio” is inclusive of the studio or live version of a song, for example, such as the type of song one might download and listen to from a popular music service, such as iTunes®. Of course, just like artist audio may include some element of unsynthesized instruments, such as piano or clarinet, the artist audio may also include some element of synthesized instruments, such as effects-driven guitar, or a MIDI-based keyboard synthesizer.

A need exists for a music synchronization system that provide a single user interface for listening to an artist audio file and/or a virtual music lesson, and provide virtual music lessons for different versions of artist audio/recordings, e.g., live or studio versions. These and other needs are addressed by the music synchronization systems and associated methods of the present disclosure.

### SUMMARY

In accordance with embodiments of the present disclosure, exemplary music synchronization systems are provided that include an electronic artist audio database including a plurality of artist audio files. The systems include an electronic data database including a plurality of data files corresponding to the respective plurality of artist audio files. Each of the data files can include data relating to fingering positions for an instrument. The systems include a processing device configured to execute a synchronization engine that receives as input an artist audio file from the electronic artist audio database and a corresponding data file from the electronic data database, and outputs via a graphical user interface a synchronized music lesson for the artist audio file.

Each of the plurality of artist audio files includes at least one instrument file corresponding to a track for the instrument. Each of the plurality of data files includes at least one instrument file corresponding to the fingering positions for the instrument. The graphical user interface can include a fingerboard representation configured to mimic at least a portion of an instrument (e.g., a guitar fretboard with strings, a piano keyboard, a banjo fretboard, a set of trumpet keys, or the like). The fingerboard representation includes indicators displayed or displayable in positions corresponding to notes of the artist audio file. The indicators can be provided for a variety of musical instruments in the form of graphical representations, as noted above.

In some embodiments, the data file corresponding to the virtual lesson can be for any instrument, whether the instrument is used in the artist audio file or not. For example, if an artist audio file includes only piano and vocals in the song, the fingerboard representation can provide a piano keyboard for the virtual lesson. As a further example, if an artist audio file includes only piano and vocals in the song, the fingerboard representation can provide a guitar fretboard for a user who cannot play piano and is learning how to play the artist audio file on guitar. Thus, users can follow the virtual lesson in real-time with a variety of instruments.

In some embodiments, the processing device can be configured to receive as input the artist audio file from the electronic artist audio database and generates a tempo map for the artist audio file. The tempo map corresponds to a variation in tempo for notes of the artist audio file and maintains synchronization between the artist audio file and the data file. In some embodiments, the processing device can be configured to receive as input the artist audio file from the electronic artist audio database and the tempo map for the artist audio file, and generates the data file corresponding to the artist audio file. In some embodiments, the processing device can be configured to execute the synchronization engine that receives as input the artist audio file from the electronic artist audio database, the tempo map for the artist audio file, and the data file corresponding to the artist audio file, and outputs via the graphical user interface the synchronized music lesson for the artist audio file.

In some embodiments, the graphical user interface can include a tempo control for regulating a tempo of the synchronized music lesson. In some embodiments, the graphical user interface can include a loop section for creating a loop within the synchronized music lesson. In some embodiments, the customized loop can be saved in the system for recall at a future time. In some embodiments, multiple customized loops can be saved in the system for recall at a future time.

In accordance with embodiments of the present disclosure, exemplary music synchronization methods are provided that include providing a plurality of artist audio files stored in an electronic artist audio database. The methods include providing a plurality of data files stored in an electronic data database. Each of the plurality of data files can correspond to the respective plurality of artist audio files and includes data relating to fingering positions for an instrument. The methods include executing a synchronization engine with a processing device that receives as input an artist audio file from the electronic artist audio database and a corresponding data file from the electronic data database, and outputs via a graphical user interface a synchronized music lesson for the artist audio file.

The graphical user interface can include a fingerboard representation. Outputting the synchronized music lesson for the artist audio file can include displaying indicators in positions on the fingerboard representation corresponding to notes of the artist audio files in a synchronized manner. In some embodiments, the methods include receiving as input the artist audio file from the electronic artist audio database and generating, with the processing device, a tempo map for the artist audio file. In some embodiments, the methods include receiving as input the artist audio file from the electronic artist audio database and the tempo file for the artist audio file, and generating with the processing device the data file corresponding to the artist audio file. In some embodiments, the methods include executing the synchronization engine that receives as input the artist audio file from the electronic artist audio database, the tempo file for the artist audio file, and the data file corresponding to the artist audio file, and outputs via the graphical user interface the synchronized music lesson for the artist audio file.

In some embodiments, the methods can include regulating a tempo of the synchronized music lesson via a tempo control of the graphical user interface. In some embodiments, the methods can include creating a loop within the synchronized music lesson via a loop section of the graphical user interface.

In accordance with embodiments of the present disclosure, an exemplary non-transitory computer readable medium storing instructions is provided. Execution of the instructions by a processing device causes the processing device to implement a method that includes storing a plurality of artist audio files in an electronic artist audio database and storing a plurality of data files in an electronic data database. Each of the plurality of data files corresponds to the respective plurality of artist audio files and includes data relating to fingering positions for an instrument. The method includes executing a synchronization engine with a processing device that receives as input an artist audio file from the electronic artist audio database and a corresponding data file from the electronic data database, and outputs via a graphical user interface a synchronized music lesson for the artist audio file.

In accordance with embodiments of the present disclosure, an exemplary music synchronization system is provided that includes an artist audio file and a data file corresponding to the artist audio file. The data file includes data relating to fingering positions for an instrument. The music synchronization system includes a processing device configured to execute a synchronization engine that receives as input the artist audio file and the data file, and outputs via a graphical user interface a synchronized music lesson for the artist audio file.

In one embodiment, the graphical user interface can include a fingerboard representation configured to mimic an instrument. The fingerboard representation can include indicators displayed in positions corresponding to notes of the artist audio file. The processing device can be configured to receive as input the artist audio file and generates a tempo map for the artist audio file. The tempo map can correspond to a variation in tempo for notes of the artist audio file and maintains synchronization between the artist audio file and the data file.

The processing device can be configured to receive as input the artist audio file and the tempo map for the artist audio file, and generates the data file corresponding to the artist audio file. The processing device can be configured to execute the synchronization engine that receives as input the artist audio file, the tempo map for the artist audio file, and the data file, and outputs via the graphical user interface the synchronized music lesson for the artist audio file. In some embodiments, the graphical user interface can include a tempo control for regulating a tempo of the synchronized music lesson.

In accordance with embodiments of the present disclosure, an exemplary method of music synchronization is provided. The method includes providing an artist audio file and providing a data file. The data file can correspond to the artist audio file and includes data relating to fingering positions for an instrument. The method includes executing a synchronization engine with a processing device that receives as input the artist audio file and the data file, and outputs via a graphical user interface a synchronized music lesson for the artist audio file.

In some embodiments, the method can include receiving as input the artist audio file and generating, with the processing device, a tempo map for the artist audio file. The method can include receiving as input the artist audio file and the tempo map for the artist audio file, and generating, with the processing device, the data file corresponding to the artist audio file. The method can include executing the synchronization engine that receives as input the artist audio file, the tempo map for the artist audio file, and the data file corresponding to the artist audio file, and outputs via the graphical user interface the synchronized music lesson for the artist audio file. In some embodiments, the method can include regulating a tempo of the synchronized music lesson via a tempo control of the graphical user interface.

In accordance with embodiments of the present disclosure, an exemplary non-transitory computer readable medium storing instructions is provided. Execution of the instructions by a processing device can cause the processing device to implement a method that includes storing an artist audio file and storing a data file. The data file can correspond to the artist audio file and includes data relating to fingering positions for an instrument. The method can include executing a synchronization engine with a processing device that receives as input the artist audio file and the data file, and outputs via a graphical user interface a synchronized music lesson for the artist audio file.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

To assist those of skill in the art in making and using the disclosed music synchronization systems and associated methods, reference is made to the accompanying figures, wherein:

FIG. 1 is a block diagram of an exemplary music synchronization system according to the present disclosure;

FIG. 2 is a block diagram of a computing device configured to implement embodiments of a music synchronization system in accordance with embodiments of the present disclosure;

FIG. 3 is a block diagram of a distributed environment for implementing embodiments of a music synchronization system in accordance with embodiments of the present disclosure;

FIG. 4 is a first embodiment of an exemplary user interface of a music synchronization system according to the present disclosure;

FIG. 5 is a first embodiment of an exemplary user interface of a music synchronization system according to the present disclosure;

FIG. 6 is a first embodiment of an exemplary user interface of a music synchronization system according to the present disclosure;

FIG. 7 is a second embodiment of an exemplary user interface of a music synchronization system according to the present disclosure; and

FIG. 8 is a flowchart illustrating implementation of a music synchronization system according to the present disclosure.

### DESCRIPTION OF EXEMPLARY EMBODIMENTS

In accordance with embodiments of the present disclosure, exemplary music synchronization systems and associated methods are provided that advantageously provide virtual music lessons to a user based on a variety of artist audio file types. The exemplary system can be in the form of computer software that can be disposed on or accessible via a mobile or a desktop software application. The system allows a user to play a song or artist audio file from a variety of methods of receiving or inputting an artist audio file into the device of the user, such as a streaming service (e.g., SPOTIFY®), a download service (e.g., iTUNES®) or recorded artist audio on a compact disc (CD) or electronic artist audio file, while providing a visual fingerboard with positions for various instruments (e.g., lead guitar, rhythm guitar, bass guitar, piano, or the like). The system includes a graphical user interface (GUI) with a fingerboard graphic representation that includes lights corresponding to fingering positions and notes to be played in synchronization with the artist audio file. The user can thereby use the virtual lesson to listen to a song and simultaneously learn how to play the corresponding instrument for the song. The user, the user can “jam along” with the artist audio, following the fingerboard positions shown in the GUI in real-time along with the playback of the artist audio file.

The system synchronizes an artist audio file and a data file for the particular instrument, and plays both files in synchronization to provide the user experience. The data file includes information corresponding to the fingering positions and/or notes in the form of a MIDI file. The MIDI file can be downloaded or streamed into the system such that when the user plays the song, both the song and the MIDI file are played in synchronization. In particular, as each note is played aurally in the artist audio music file for the song, the data file can simultaneously provide a visual representation on the virtual fingerboard for the position of the user's fingers on a particular instrument.

As will be discussed in greater detail below, the system can provide the user with additional features for modifying the artist audio file and/or the data file for an improved virtual lesson experience. For example, the system includes features for slowing down the song tempo, setting a start and stop point, thereby creating a loop to play a portion of the song repetitively, or the like. When slowing down the tempo, the artist audio file can be slowed down such that the pitch of the song will stay the same. In some embodiments, when the tempo is slowed down below 100% tempo, e.g., 99% or slower, a separate MIDI audio track can be used and played at the original pitch of the artist audio file.

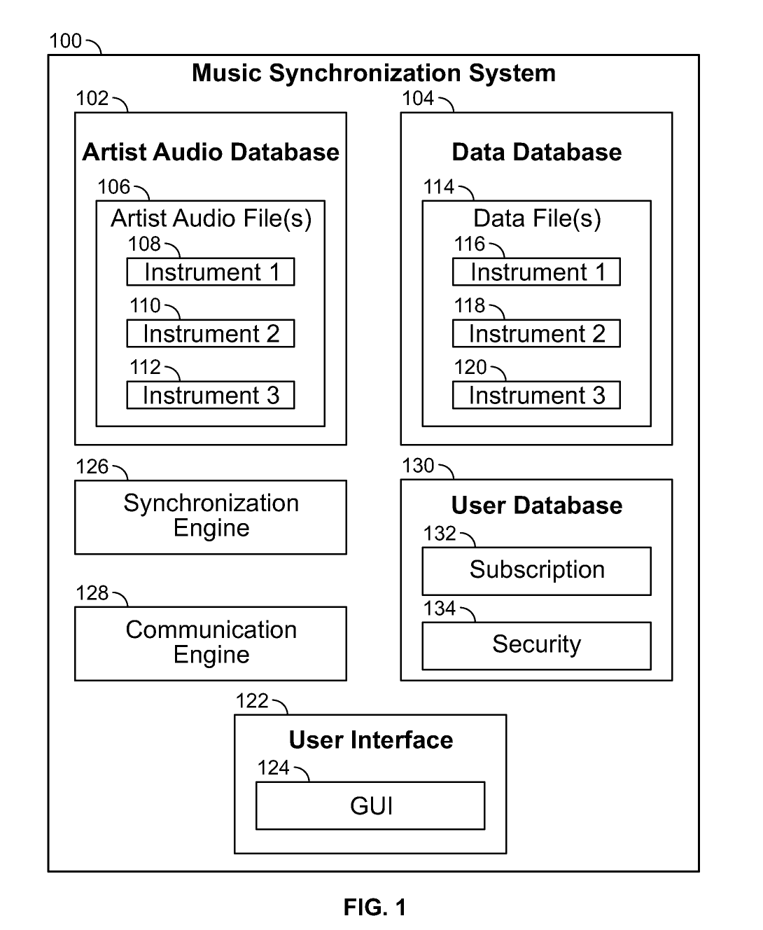

With reference to FIG. 1, a block diagram of an exemplary music synchronization system 100 (hereinafter “system 100”) is provided. The components of the system 100 discussed herein can be communicatively connected relative to each other through wired and/or wireless connection. In particular, the components of the system 100 can be configured to transmit and/or receive data relative to each other. The system 100 includes an artist audio database 102 and a data database 104. The artist audio and data databases 102, 104 can be located on a single computing device or can be distributed over multiple computing devices and/or cloud-based servers.

The artist audio database 102 includes one or more artist audio files 106 corresponding to a recording by an artist. Each artist audio file 106 includes one or more instrument files 108-112 that correspond to musical instruments and/or vocal tracks. For example, the instrument file 108 can correspond to a rhythm guitar track, the instrument file 110 can correspond to a lead guitar track, and the instrument file 112 can correspond to a vocal track. It should be understood that each artist audio file 106 can include separate instrument files for each instrument and/or vocal track in the artist audio recording (e.g., lead vocals, backup vocals, lead guitar, rhythm guitar, bass guitar, drums, piano, or the like). In some embodiments, one of the instrument files 108-112 can correspond to an audio lesson by a teacher explaining portions of a song. For example, the artist audio file 106 can be an audio lesson of a teacher explaining the guitar fingering displayed to the user via the corresponding data file 114.

The artist audio file 106 can be a streaming file or a recorded artist audio. The artist audio file 106 can be in the form of a wav, iTUNES®, GOOGLE PLAY®, MP3, streamed audio, or other audio which exhibits the characteristics of a stereo audio recording with a left and right channel. In some embodiments, the source of the artist audio file 106 can be from the iTUNES® library of the user. However, the artist audio file 106 can allow the user to choose the source of the artist audio file 106 from a variety of locations, e.g., a compact disc (CD) downloaded onto the computer or mobile device, an MP3 file, or a streaming service. The artist audio list section of the graphical user interface can include a column to reflect the different sources of the artist audio file 106.

The data database 104 includes one or more data files 114 corresponding to a recording by an artist. Each data file 114 includes one or more instrument files 116-120 that correspond to musical instruments and/or vocal tracks associated with a particular artist audio file 106. The data files 114 can include information on finger positioning for providing the musical lesson to a user through a graphical user interface. In some embodiments, the source of the data file 114 can be a MIDI file that resides on a cloud-based server. When the user completes a successful subscription, the data file 114 corresponding to the fingering data can be pulled from the cloud-based server to the system 100 and the data file 114 can reside on the computing or mobile device of the user. It should be understood that the data file 114 can be streamed or can reside in different locations and imported or downloaded onto the computing or mobile device in a variety of methods.

The system 100 can include a user interface 122 with a GUI 124 for providing an instructional music lesson to the user. In some embodiments, the GUI 124 can include a virtual fingerboard representation on which positioning the proper notes to be played and positioning of the user's fingers can be displayed to the user. For example, the fingerboard representation can be in the form of a guitar fingerboard, a bass guitar fingerboard, piano keys, or the like. It should be understood that the examples of the fingerboard representation are for illustrative purposes only, and that alternative instrument representations can be provided by the system 100. The GUI 124 also allows for input from the user regarding the music lesson provided via the GUI 124.

The system 100 includes a synchronization engine 126 configured to programmatically synchronize an instrument file 116-120 of the data file 114 with an appropriate instrument file 108-112 of the artist audio file 106. For example, the synchronization engine 126 can receive as input an instrument file 108 of an artist audio file 106 corresponding to a lead guitar track and an instrument file 116 of a data file 114 corresponding to the fingerboard positioning for the lead guitar track. The synchronization engine 126 synchronizes the two files such that the artist audio track from the instrument file 108 and the visual lesson from the instrument file 116 are provided to the user in a synchronized manner, with each portion of the visual lesson being displayed at the exact moment of playing the artist audio track.

In some embodiments, to synchronize the fingerboard data from the data file 114 with the artist audio file 106 of the same song, a tempo map can be generated by the synchronization engine 126 for each song and the correct motions or fingering for the different instrument parts can be input either by playing the parts on a MIDI player (e.g., a MIDI guitar) and recording the inputs, or step-inputting the notes in a MIDI editor. The tempo map determines the tempo for the duration of each song. In particular, a song may not be the same tempo throughout the length of the song. For example, the tempo of a song recorded by an artist (studio or live) may vary between a first tempo, e.g., 120 beats per minute (BPM), and a second tempo different from the first tempo, e.g., 118 BPM. As a further example, a live recording of an artist can include a variation in the tempo that does not typically exist in a studio recording of the same song. The tempo map determines the variation in tempo throughout the song and ensures that an accurate synchronization between the artist audio file 106 and the data file 114 is achieved. In particular, the tempo map allows for mirroring of the artist audio file 106 with the motions or fingering displayed by the data file 114, including the start time, note values and/or duration. Thus, a variety of songs (including live recordings) can be provided with accurate mapping and synchronization for providing the virtual lesson.

The system 100 can include a communication engine 128 configured to programmatically allow for communication between the artist audio database 102, the data database 104, the synchronization engine 126, the user interface 122, and the user database 130. For example, the communication engine 128 transmits the artist audio file 106 and the data file 114 to the synchronization engine 126, and further transmits the synchronized artist audio/data file output from the synchronization engine 126 to the user interface 122.

In some embodiments, the system 100 can include the user database 130 for electronically storing data corresponding to specific users of the system 100. The user database 130 can include subscription information 132 and security information 134. The subscription information 132 can include data corresponding to whether a user has subscribed to the synchronization service provided by the system 100, the length of the subscription, or the like. For example, the system 100 can include an option for payment for a subscription or per song to obtain the synchronized lessons. The security information 134 can include data corresponding to an alphanumeric username and password associated with each user. Thus, the user can log in to the system 100 for accessing the synchronized musical lessons via the GUI 124.

In some embodiments, the fingerboard representation of the system 100 can be encrypted and when a user creates an account, the computing device or mobile device media access control (MAC) address can be coded to the system 100 to avoid abuse of multiple downloads or scamming the subscription or trial system. As will be discussed in greater detail below, the system 100 can indicate to the user if a virtual lesson is available for a particular artist audio song that the user does not currently own, indicating that the user must purchase the artist audio song to play/hear the artist audio song and visualize the virtual lesson for the song.

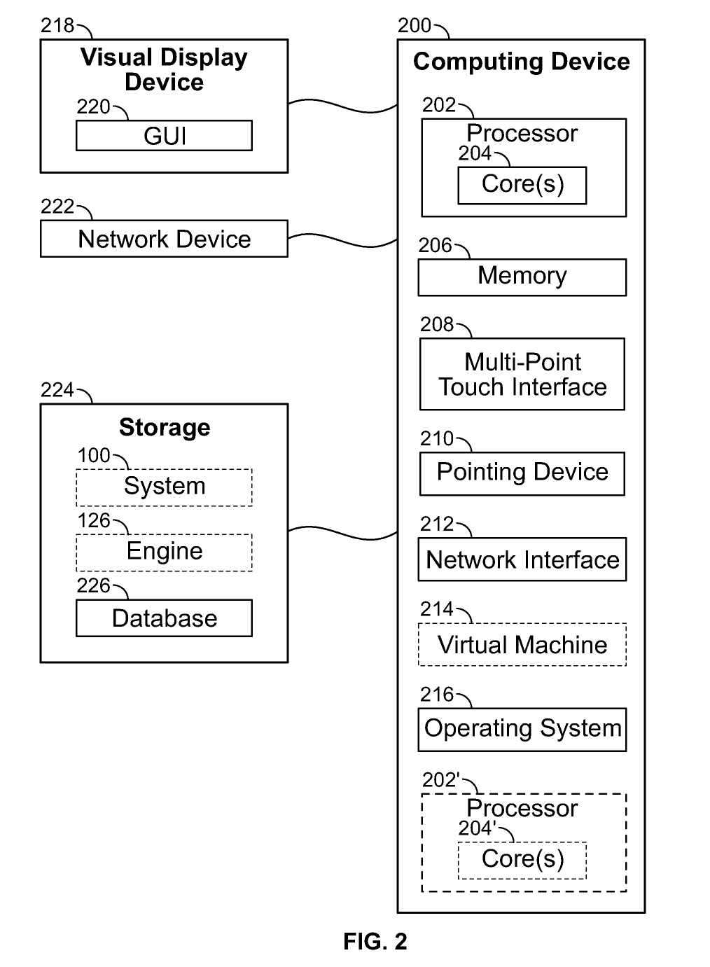

FIG. 2 is a block diagram of a computing device 200 configured to implement embodiments of the system 100 in accordance with embodiments of the present disclosure. The computing device 200 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 206 included in the computing device 200 may store computer-readable and computer-executable instructions or software for implementing exemplary embodiments of the present disclosure (e.g., the synchronization engine 126, the communication engine 128, combinations thereof, or the like). The computing device 200 also includes configurable and/or programmable processor 202 and associated core 204, and optionally, one or more additional configurable and/or programmable processor(s) 202′ and associated core(s) 204′ (for example, in the case of computer systems having multiple processors/cores), for executing computer-readable and computer-executable instructions or software stored in the memory 206 and other programs for controlling system hardware. Processor 202 and processor(s) 202′ may each be a single core processor or multiple core (204 and 204′) processor.

Virtualization may be employed in the computing device 200 so that infrastructure and resources in the computing device may be shared dynamically. A virtual machine 214 may be provided to handle a process running on multiple processors so that the process appears to be using only one computing resource rather than multiple computing resources. Multiple virtual machines may also be used with one processor.

Memory 206 may include a computer system memory or random access memory, such as DRAM, SRAM, EDO RAM, and the like. Memory 206 may include other types of memory as well, or combinations thereof.

A user may interact with the computing device 200 through a visual display device 218, such as a computer monitor, which may display one or more graphical user interfaces 220 that may be provided in accordance with exemplary embodiments (e.g., the user interface 122 with the GUI 124). The computing device 200 may include other I/O devices for receiving input from a user, for example, a keyboard or any suitable multi-point touch interface 208, a pointing device 210 (e.g., a mouse), or the like. The keyboard 208 and the pointing device 210 may be coupled to the visual display device 218. The computing device 200 may include other suitable conventional I/O peripherals.

The computing device 200 may also include one or more storage devices 224, such as a hard-drive, CD-ROM, or other computer readable media, for storing data and computer-readable instructions and/or software that implement exemplary embodiments of the system 100 described herein. Exemplary storage device 224 may also store one or more databases 226 for storing any suitable information required to implement exemplary embodiments. For example, exemplary storage device 224 can store one or more databases 226 for storing information, such as data stored within the artist audio database 102, the data database 104, the user database 130, combinations thereof, or the like, and computer-readable instructions and/or software that implement exemplary embodiments described herein. The databases 226 may be updated by manually or automatically at any suitable time to add, delete, and/or update one or more items in the databases 226.

The computing device 200 can include a network interface 212 configured to interface via one or more network devices 222 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 212 may include a built-in network adapter, network interface card, PCMCIA network card, card bus network adapter, wireless network adapter, USB network adapter, modem or any other device suitable for interfacing the computing device 200 to any type of network capable of communication and performing the operations described herein. Moreover, the computing device 200 may be any computer system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 200 may run any operating system 216, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 216 may be run in native mode or emulated mode. In an exemplary embodiment, the operating system 216 may be run on one or more cloud machine instances.

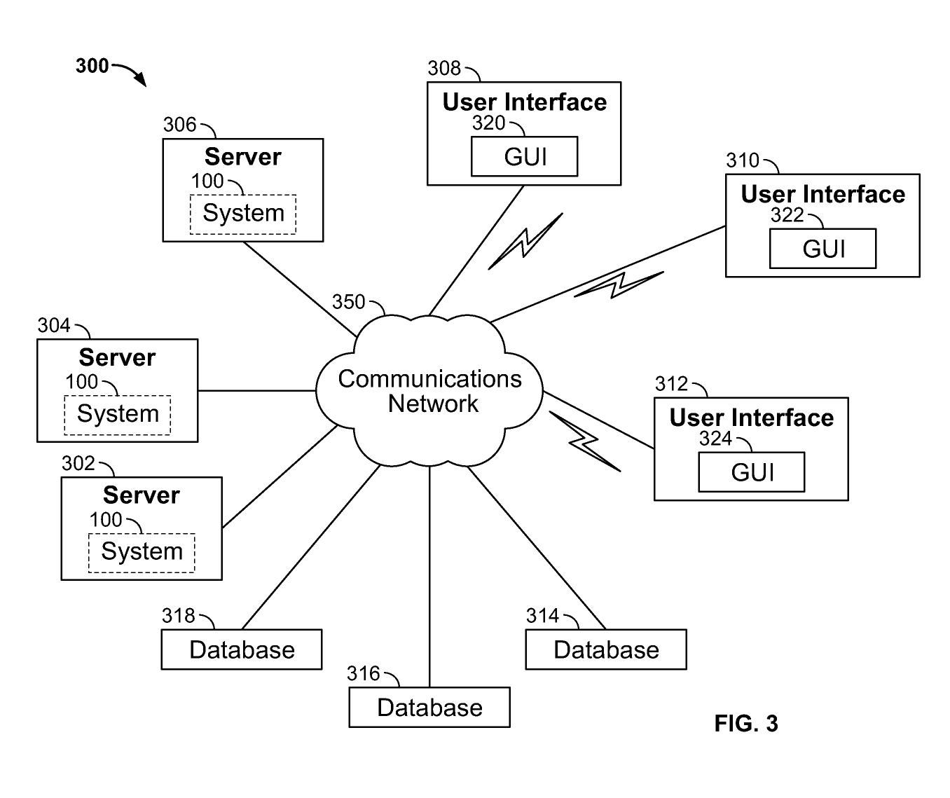

FIG. 3 is a block diagram of a distributed environment 300 for implementing embodiments of the system 100 in accordance with embodiments of the present disclosure. The environment 300 can include servers 302-306 operatively coupled to one or more user interfaces 308-312, and databases 314-318, via a communication network 350, which can be any network over which information can be transmitted between devices communicatively coupled to the network. For example, the communication network 350 can be the Internet, Intranet, virtual private network (VPN), wide area network (WAN), local area network (LAN), and the like. The environment 300 can include repositories or database devices 314-318, which can be operatively coupled to the servers 302-306, as well as to user interfaces 308-312, via the communications network 350. In exemplary embodiments, the servers 302-306, user interfaces 308-312, and database devices 314-318 can be implemented as computing devices (e.g., computing device 200). Those skilled in the art will recognize that the database devices 314-318 can be incorporated into one or more of the servers 302-306 such that one or more of the servers 302-306 can include the databases 314-318.

In some embodiments, the database 314 can store information relating to the artist audio database 102, the database 316 can store information relating to the data database 104, and the database 318 can store information relating to the user database 130. In some embodiments, information relating to the artist audio database 102, the data database 104, and the user database 130 can be distributed over one or more of the databases 314-318.

In some embodiments, one or more of the servers 302-306 can be configured to implement one or more components of the system 100. In some embodiments, the synchronization engine 126 and the communication engine 128 can be implemented in a distributed configuration over the servers 302-306. For example, the server 302 can implement the synchronization engine 126, the server 304 can implement the communication engine 128, and the server 306 can implement one or more remaining portions of the system 100. In some embodiments, the user interfaces 308-312 include a GUI 320-324 for presenting information to the user.

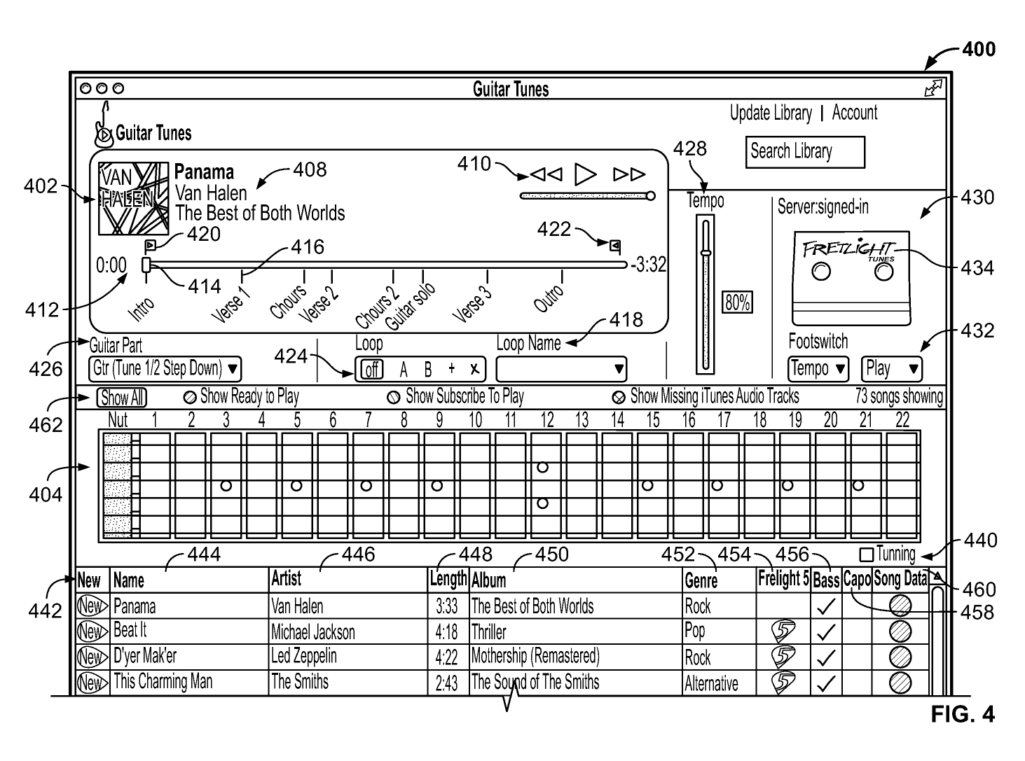

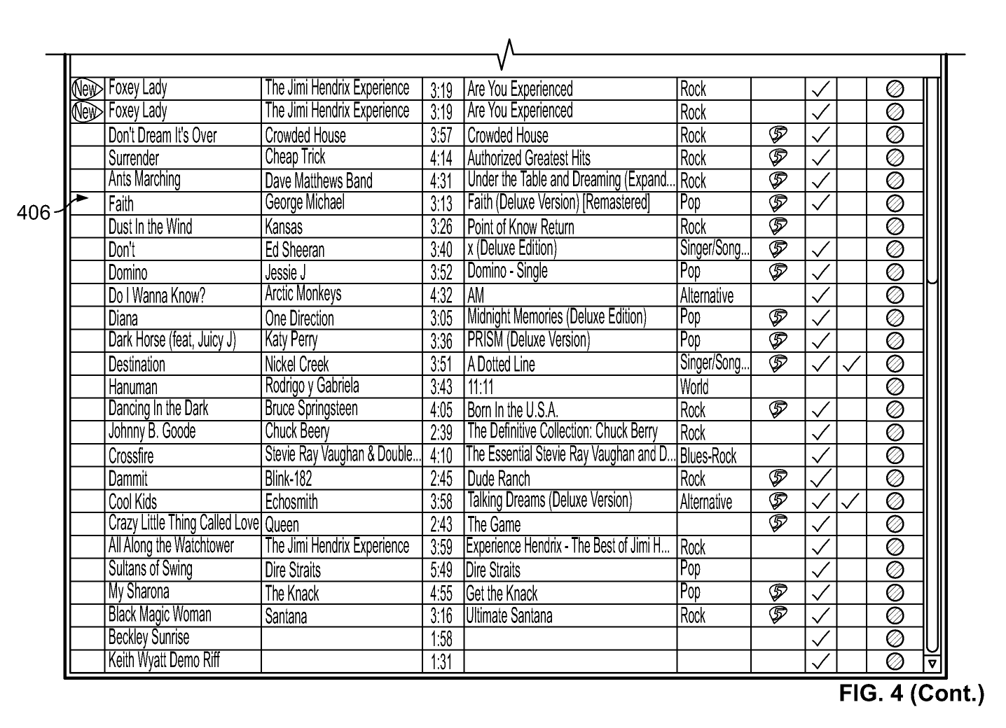

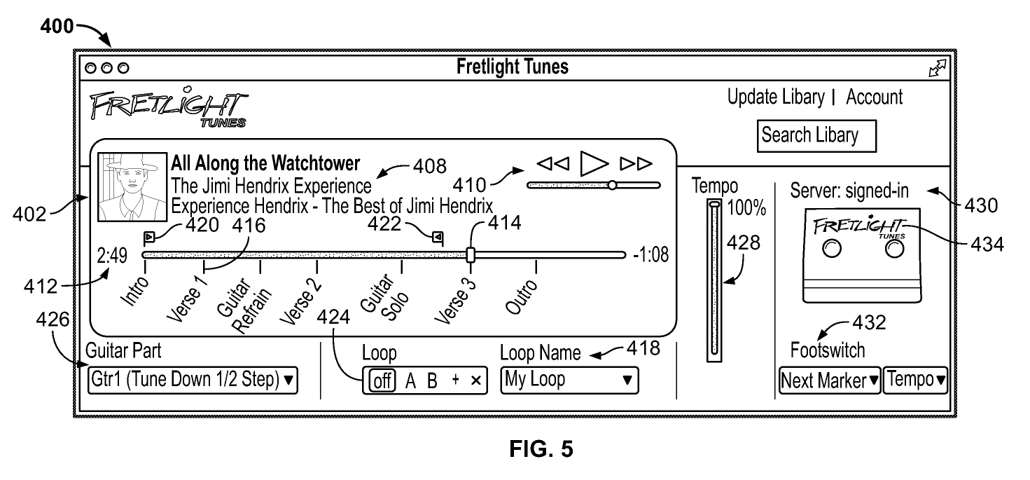

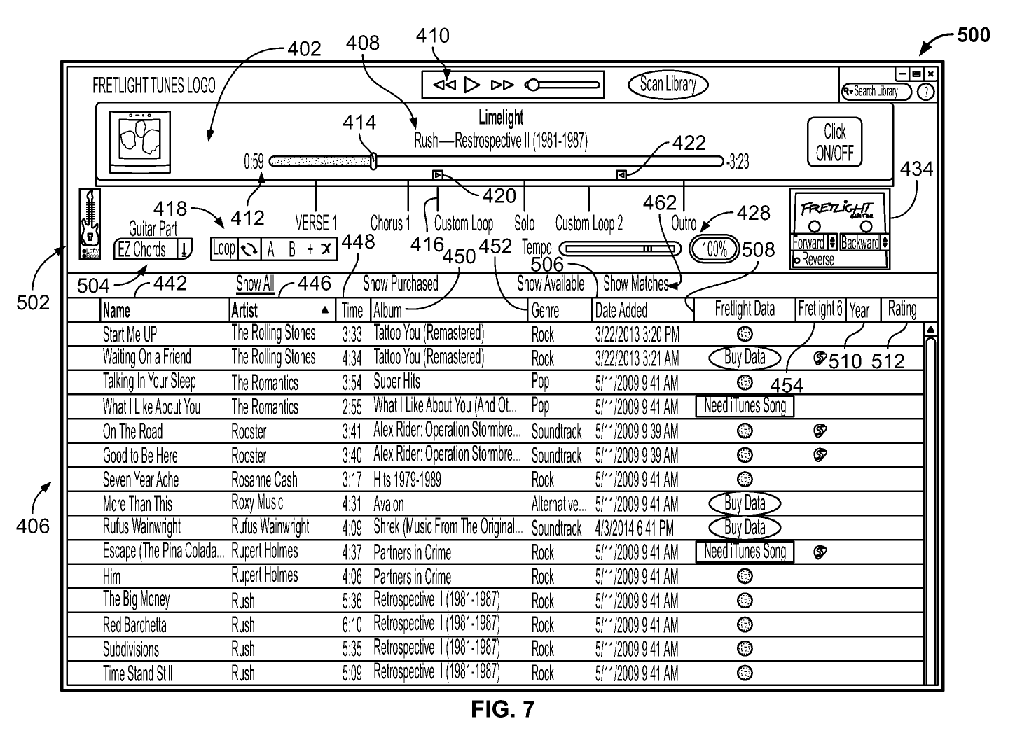

FIGS. 4-6 are views of a first embodiment of an exemplary GUI 400 of the system 100. FIG. 7 is a view of a second embodiment of an exemplary GUI 500 of the system 100. The GUI 500 can be substantially similar in structure and/or function to the GUI 400, except for the distinctions noted herein. Therefore, like reference numbers are used to represent like structures and/or functions.

The GUI 400 includes an artist audio section 402, a fingerboard representation 404, and an artist audio list section 406. The artist audio section 402 provides song information 408 associated with an artist audio file being played, including the song name, artist name, album name, album cover, combinations thereof, or the like. The artist audio section 402 includes playback controls 410 for playing, stopping, rewinding and fast-forwarding the artist audio file.

The artist audio section 402 further includes an artist audio timeline 412 with the opposing ends representing the beginning and ending of the artist audio file. The artist audio timeline 412 provides a visualization of the current section of the artist audio file being listened to and the specific song section. In particular, the artist audio timeline 412 includes a marker 414 indicating the point of the song currently being listened to. In some embodiments, the artist audio timeline 412 can include markers 416 positioned along the artist audio timeline 412 and corresponding to specific sections of the artist audio file, such as the introduction, verse 1, verse 2, chorus 1, chorus 2, bridge, guitar solo, outro, or the like, for a song, or part 1, part 2, practice session, or the like, for an artist audio lesson. Thus, for example, the user can view the timeline and see that an artist audio file is at the 2:30 minute mark and in the middle of chorus 3. In some embodiments, the artist audio timeline 412 can be provided in a vertical listing of the sections or any other configuration for showing the musical timeline of the artist audio file. For example, the artist audio timeline 412 can be in the form of sheet music or tablature which can be synchronized along with the MIDI data file and the artist audio file. Looping may be desirable, for example, for the user who wants to practice “jamming along” to the same part of a section repetitively, so as to practice that part of the song.

The artist audio section 402 can include a loop section 418 for creating loops within the artist audio file for repetitive learning of specific portions of a song. The loop section 418 can be used to manipulate the artist audio file for customized learning of the song. A loop can be created in a number of ways. In some embodiments, the artist audio timeline 412 can include a starting point 420 and an ending point 422 in the form of, for example, flags. The starting and ending points 420, 422 can be dragged by the user along the artist audio timeline 412 to set the starting point (e.g., A) and the ending point (e.g., B) for the loop. Playing the artist audio file can thereby be limited between the starting and ending points 420, 422. The user can set the loop with the starting and ending points 420, 422 before playing the artist audio file or during playing of the artist audio file. For example, while visualizing the position of the marker 414 during playing of the artist audio file, the user can determine where the starting and ending points 420, 422 should be positioned to create the loop. The user can also create a loop by selecting the particular sections of the song indicated by the markers 416, e.g., a loop between verse 1 and verse 2. The user can save the loops and create customized names for each loop for subsequent instant recall. The loop section 418 can include a master switch 424 for turning the loop on or off. Thus, even if the loop is shown on the artist audio timeline 412, the master switch 424 can be used to override the loop and play the entire artist audio file.

The artist audio section 402 can include an instrument selection 426. In some embodiments, the instrument selection 426 can be in the form of a dropdown selection. The instrument selection 426 allows the user to select the particular instrument the user would like to visualize on the fingerboard representation 404 and/or learn for the artist audio file. For example, the user can select the rhythm guitar, lead guitar, bass guitar, or the like. The instrument selection 426 can provide the user with information regarding tuning of the particular instrument, such as tuning a guitar a half step down from standard tuning. In some embodiments, the artist audio section 402 includes a selection 502 (see FIG. 7) that allows the user to choose the instrument of interest, such as the guitar or bass.

In some embodiments, the instrument selection 426 can provide the ability for a user to select whether an “easy chords” or an “open chord” track is provided on the fingerboard representation 404. With respect to guitars, the “easy chord” track can correspond to chords being played on the first five frets and the “open chords” track can correspond to barre and/or open or non-barre chords. In some embodiments, the artist audio file and/or the fingerboard representation 404 can provide the actual notes being played by the song and another track can be transposed over the artist audio file and/or the fingerboard representation 404 based on the selection of the user. For example, while the artist audio file and/or the fingerboard representation 404 play or show the rhythm guitar portion, the lead guitar portion can be simultaneously transposed over the fingerboard representation 404.

The artist audio section 402 can include a tempo control 428 that allows the user to vary the tempo of the artist audio file and the synchronized lesson on the fingerboard representation 404. For example, the user can slow the artist audio file and the synched MIDI file to learn a song at a slower guitar fingering pace. In some embodiments, the artist audio file can be slowed to actually hear the artist audio itself slowed down. In the alternative, when the tempo control 428 is moved below the 100% mark (e.g., 99% or slower), a MIDI track represented as another audio track on the MIDI file can be heard instead of the actual artist audio file recording. For example, the actual artist audio file can be muted and the MIDI file can be played. The pitch of the MIDI file can remain the same pitch as the 100% tempo of the artist audio file. In particular, because MIDI is a digital file and not audio, slowing down the MIDI file does not change the original pitch of the notes. The pitch thereby remains the same even in the slowed down version of the MIDI file. In some embodiments, when the MIDI track is used at a tempo of 99% or lower, a click track option can be provided such that the user can keep timing of the part the user is attempting to play.

The GUI 400 can include a log in section 430 that indicates whether the user is logged in to the server providing the artist audio file and/or the data file to the user. In some embodiments, the log in section 430 can provide additional information to the user regarding the system 100.

The GUI 400 can include a footswitch section 432. In some embodiments, a Bluetooth or wired footswitch (e.g., a PAGEFLIP® Automatic Page Turner, or the like) can be connected to the system 100 and pairs with the system 10 to allow for control of various options for the user to enhance the user experience. The footswitch section 432 can be used to control a variety of options, such as change or affect the tempo control, start/stop, rewind, fast forward, select a guitar part, skip to the next song section, create a loop, turn the loop on/off, or the like. A graphic representation 434 can provide a visualization with one or more lights to indicate whether the footswitch is active. In some embodiments, the graphic representation 434 can be activated through a touchscreen such that the user can change settings based on pressure applied to portions of the graphic representation 434.

The fingerboard representation 404 can display the notes and/or fingering positions needed to play the particular instrument portion selected. Although illustrated as a guitar fretboard, it should be understood that the fingerboard representation 404 can be in the form of, e.g., a piano keyboard, banjo fretboard, ukulele fretboard, or any other instrument for which the virtual lesson is provided. With respect to a guitar lesson, the fingerboard representation 404 can display the strings on the guitar and each individual fret. If a user selects the bass guitar lesson for a song, the fingerboard representation 404 can change to a representation of a bass guitar with four strings. If a user selects a piano lesson for a song, the fingerboard representation 404 can change to a representation of a piano keyboard. If a user is left-handed, a left-handed mode can be selected via selection 502 (see FIG. 7) to flip the fingerboard representation 404 from left to right in order to represent a left-handed view for a left-handed musician.

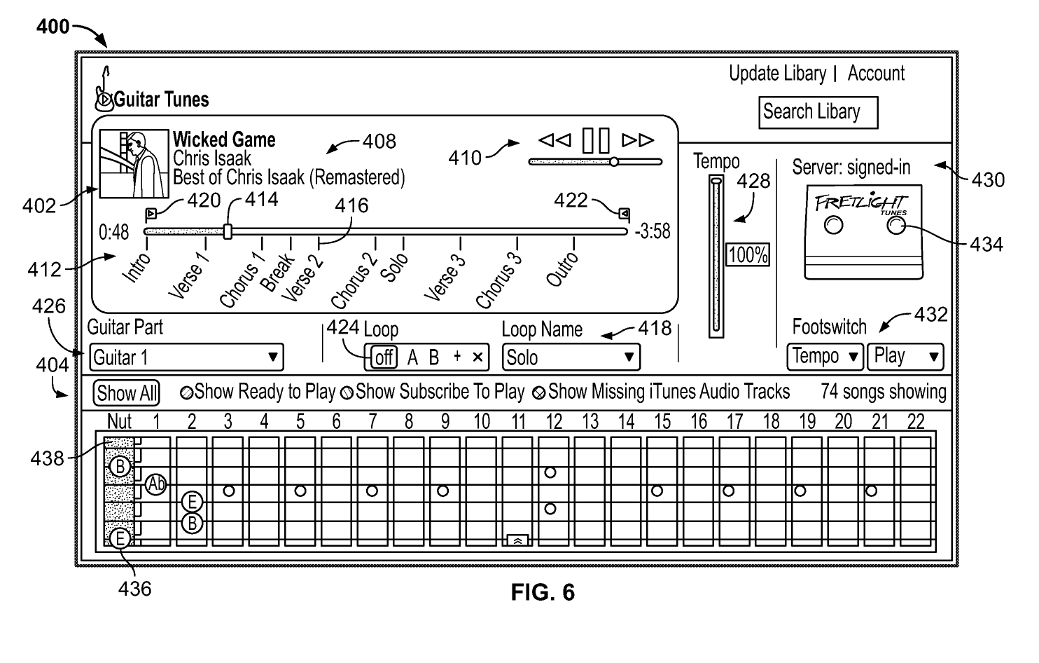

As illustrated in FIG. 6, during the virtual lesson, indicators 436 (e.g., circular indicators in the form of one or more light emitting diodes, or the like) can be displayed on the fretboard at the specific fret and string to be played and corresponding to the notes in the artist audio file. In particular, as the artist audio file plays, the indicators 436 corresponding to the notes in the artist audio file can change and move in a synchronized manner with the artist audio file to provide a virtual lesson to the user. The user can thereby follow the indicators 436 to play along with the artist audio file on the user's instrument. In some embodiments, the indicator 436 can include text within the indicator 436 that provides the note name (e.g., notes E, B or A_{b} shown in FIG. 6). In some embodiments, the indicator 436 can include a numeral within the indicator 436 which indicates the finger to be used to play the note (e.g., number 3 to indicate the ring finger). The fingerboard representation 404 can show open string notes by positioning the indicator 436 on or behind the nut 438.

In some embodiments, the user can choose whether to visualize the entire fingerboard representation 404 or enable a “smart” fingerboard representation mode. The “smart” fingerboard representation mode can analyze the selected portion of the artist audio file currently being played and can zoom in on the section of the fingerboard representation 404 that includes the frets that are used for the selected portion. For example, if a particular guitar part of the selected song is played from frets three to twelve, the fingerboard representation 404 can zoom in to those frets. The user can further choose to pinch and zoom the fingerboard representation 404 through a touchscreen or zoom in using an input device (e.g., a mouse) to customize the fingerboard representation 404 to any size regardless of where the indicators 436 are located along the fingerboard representation 404. In some embodiments, the user can choose, drag and place the fingerboard representation 404 in a floating window separate from the main window displayed on the GUI 400 (e.g., at the top, middle or bottom of a display screen).

In some embodiments, the GUI 400 can include a tuning mode selection 440. The tuning mode selection 440 allows the user to tune the instrument by, e.g., touching or clicking the strings on the fingerboard representation 404, to produce a tone of each string, the tone decaying after a few seconds as a real instrument would do. In some embodiments, touching or clicking the string can produce a tone, decay and repeat the tone and decay until the user either touches or clicks another string or turns off the tuning mode selection 440.

In some embodiments, actuation of the tuning mode selection 440 can display a digital meter representation of a tuner (e.g., a digital guitar tuner) such that instead of tuning to a tone, the user can tune to a needle which, when centered, indicates to the user that the particular string is in tune. Since many songs are not recorded in standard tuning, the tuning function of the system 100 can coordinate the appropriate tuning based on the selected artist audio file. In particular, the tuning of songs can be open tuning, slightly sharp or flat, or the like, because the instruments were not in standard tuning when the song was recorded. Thus, when a particular artist audio file is selected and ready to play, a specialized tuning track from the data or MIDI file of the specific artist audio file can be loaded into the tuning function such that the user can tune the instrument for the selected artist audio file.

The artist audio list section 406 includes a table of information relating to artist audio files and/or lessons available to the user. The artist audio list section 406 can include columns 442-460 that provide a variety of information, including variables related to the artist audio files listed. The columns 442-460 can be clicked on to sort the listing by the variable associated with the column 442-460. As an example, column 442 can indicate if the artist audio file is new. Column 444 can indicate the name of the artist audio file. Column 446 can indicate the name of the artist. Column 448 can indicate the length of the artist audio file. Column 450 can indicate the album name. Column 452 can indicate the genre of the artist audio file. Column 454 can indicate whether a virtual lesson is available for the artist audio file. Column 456 can indicate whether alternative instrument lessons are available for the artist audio file (e.g., if a user is viewing a guitar lesson and a bass guitar lesson is available for the artist audio file). Column 458 can indicate whether a capo is needed for the artist audio file. If a capo is needed, the system 100 can assume that the user will install a capo on the instrument and provides a graphical representation of a capo in the appropriate location of the fingerboard representation 404.

Column 460 can indicate by various colors whether the song data file is available for viewing by the user. For example, a green circle can indicate that the user has access to both the song data file and the song audio file, and can view the virtual lesson. A red circle can indicate that the user is missing one of the parts (e.g., an artist audio file and/or a data file) and cannot view the virtual lesson until the appropriate file is obtained. The matrix of artist audio files can be filtered and sorted as the user prefers by choosing the appropriate variables or clicking/selecting the columns 442-460. For example, the GUI 400 can include a filter selection 462 for filtering the artist audio list section 406.

The filter selection 462 can have an option for showing all of the songs, showing artist audio files with already-obtained data files and available for the user to view (e.g., a green light), showing artist audio files with data files available for download or purchase through a subscription (e.g., a yellow light), and artist audio files missing from the user's artist audio list section 406 for which data files are available through the system 100 (e.g., a red light). For example, the system can alert the user when data files are available for artist audio files that the user does not currently own. In some embodiments, the artist audio list section 406 can include a column 508 providing a green light for songs with an artist audio file and a data file available to the user, and providing text such as “Buy Data” or “Need Song” for files missing the data file or the artist audio file. Clicking on the text can act as a link to send the user to the appropriate location for obtaining the data file and/or artist audio file.

It should be understood that the artist audio list section 406 can include a variety of additional columns, including a column indicating whether outside sources of tablature or virtual lessons are available for the artist audio file (or alternatively a drop down selection 504 (see FIG. 7) for selection of a lesson from an outside source), a column indicating the difficulty of the artist audio file, a column indicating the number of parts or sections in the artist audio file, a column 506 representing the date the artist audio file was added to the artist audio list section 406, a column 510 indicating the year of the artist audio file recording, a column 512 providing a rating for the song, or the like (see FIG. 7).

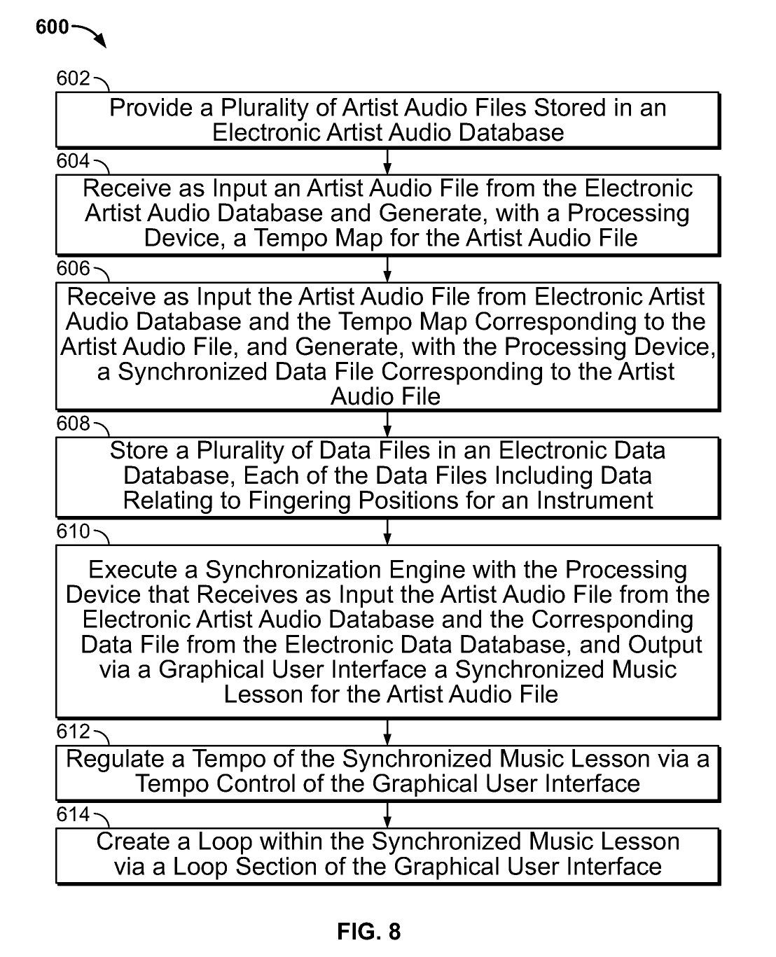

FIG. 8 is a flowchart illustrating an exemplary music synchronization process 600 as implemented by the system 100 in accordance with embodiments of the present disclosure. It should be understood that the steps shown in FIG. 8 can be interchanged, rearranged or removed depending on operation of the system 100. To begin, at step 602, a plurality of artist audio files stored in an electronic artist audio database can be provided. At step 604, a processing device can receive as input an artist audio file from the electronic artist audio database and generates a tempo map for the artist audio file. At step 606, the processing device can receive as input the artist audio file from the electronic artist audio database and the tempo map corresponding to the artist audio file, and generates a synchronized data file corresponding to the artist audio file.

At step 608, a plurality of data files are stored in an electronic data database, each of the data files including data relating to fingering positions for an instrument. At step 610, a synchronization engine can be executed by the processing device that receives as input the artist audio file from the electronic artist audio database and the corresponding data file from the electronic data database, and outputs via a graphical user interface a synchronized music lesson for the artist audio file. Optionally, at step 612, a tempo of the synchronized music lesson can be regulated via a tempo control of the graphical user interface. Optionally, at step 614, a loop can be created within the synchronized music lesson via a loop section of the graphical user interface.

The exemplary systems and methods described herein thereby allow the user to visualize virtual music lessons for a variety of song types available on the user's computing or mobile device with synchronized fingering positions on a fingerboard representation. In particular, the music lessons can be provided for studio and live recordings (or any recoding, such as a guitar lesson where an instructor gives verbal instructions and playing examples where the examples are synchronized and shown on the graphical interface). By generating a tempo map for the artist audio file and synchronizing the data file to the tempo map, the systems provide accurate and synchronized lessons that results in an improved user experience.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A music synchronization system, comprising:
an electronic artist audio database including a plurality of artist audio files;
an electronic data database including a plurality of data files corresponding to the respective plurality of artist audio files, each of the data files including data relating to fingering positions for an instrument;
a processing device configured to execute a synchronization engine that receives as input an artist audio file from the electronic artist audio database and a corresponding data file from the electronic data database, and outputs via a graphical user interface a synchronized music lesson for the artist audio file.

2. The system of claim 1, wherein each of the plurality of artist audio files comprises at least one instrument file corresponding to a track for the instrument.

3. The system of claim 1, wherein each of the plurality of data files comprises at least one instrument file corresponding to the fingering positions for the instrument.

4. The system of claim 1, wherein the graphical user interface comprises a fingerboard representation configured to mimic an instrument.

5. The system of claim 4, wherein the fingerboard representation comprises indicators displayed in positions corresponding to notes of the artist audio file.

6. The system of claim 5, wherein the fingerboard representation is a guitar fretboard with strings.

7. The system of claim 1, wherein the processing device is configured to receive as input the artist audio file from the electronic artist audio database and generates a tempo map for the artist audio file.

8. The system of claim 7, wherein the tempo map corresponds to a variation in tempo for notes of the artist audio file and maintains synchronization between the artist audio file and the data file.

9. The system of claim 7, wherein the processing device is configured to receive as input the artist audio file from the electronic artist audio database and the tempo map for the artist audio file, and generates the data file corresponding to the artist audio file.

10. The system of claim 7, wherein the processing device is configured to execute the synchronization engine that receives as input the artist audio file from the electronic artist audio database, the tempo map for the artist audio file, and the data file corresponding to the artist audio file, and outputs via the graphical user interface the synchronized music lesson for the artist audio file.

11. The system of claim 1, wherein the graphical user interface comprises a tempo control for regulating a tempo of the synchronized music lesson.

12. The system of claim 1, wherein the graphical user interface comprises a loop section for creating a loop within the synchronized music lesson.

13. A method of music synchronization, comprising:
providing a plurality of artist audio files stored in an electronic artist audio database;
providing a plurality of data files stored in an electronic data database, each of the plurality of data files corresponding to the respective plurality of artist audio files and including data relating to fingering positions for an instrument; and
executing a synchronization engine with a processing device that receives as input an artist audio file from the electronic artist audio database and a corresponding data file from the electronic data database, and outputs via a graphical user interface a synchronized music lesson for the artist audio file.

14. The method of claim 13, wherein the graphical user interface comprises a fingerboard representation and outputting the synchronized music lesson for the artist audio file comprises displaying indicators in positions on the fingerboard representation corresponding to notes of the artist audio file.

15. The method of claim 13, comprising receiving as input the artist audio file from the electronic artist audio database and generating, with the processing device, a tempo map for the artist audio file.

16. The method of claim 15, comprising receiving as input the artist audio file from the electronic artist audio database and the tempo map for the artist audio file, and generating, with the processing device, the data file corresponding to the artist audio file.

17. The method of claim 16, comprising executing the synchronization engine that receives as input the artist audio file from the electronic artist audio database, the tempo map for the artist audio file, and the data file corresponding to the artist audio file, and outputs via the graphical user interface the synchronized music lesson for the artist audio file.

18. The method of claim 13, comprising regulating a tempo of the synchronized music lesson via a tempo control of the graphical user interface.

19. The method of claim 13, comprising creating a loop within the synchronized music lesson via a loop section of the graphical user interface.

20. A non-transitory computer readable medium storing instructions, wherein execution of the instructions by a processing device causes the processing device to implement a method, comprising:
storing a plurality of artist audio files in an electronic artist audio database;
storing a plurality of data files in an electronic data database, each of the plurality of data files corresponding to the respective plurality of artist audio files and including data relating to fingering positions for an instrument; and
executing a synchronization engine with a processing device that receives as input an artist audio file from the electronic artist audio database and a corresponding data file from the electronic data database, and outputs via a graphical user interface a synchronized music lesson for the artist audio file.

21. A music synchronization system, comprising:
an artist audio file;
a data file corresponding to the artist audio file, the data file including data relating to fingering positions for an instrument; and
a processing device configured to execute a synchronization engine that receives as input the artist audio file and the data file, and outputs via a graphical user interface a synchronized music lesson for the artist audio file.

22. The system of claim 21, wherein the graphical user interface comprises a fingerboard representation configured to mimic an instrument.

23. The system of claim 22, wherein the fingerboard representation comprises indicators displayed in positions corresponding to notes of the artist audio file.

24. The system of claim 21, wherein the processing device is configured to receive as input the artist audio file and generates a tempo map for the artist audio file.

25. The system of claim 24, wherein the tempo map corresponds to a variation in tempo for notes of the artist audio file and maintains synchronization between the artist audio file and the data file.

26. The system of claim 24, wherein the processing device is configured to receive as input the artist audio file and the tempo map for the artist audio file, and generates the data file corresponding to the artist audio file.

27. The system of claim 24, wherein the processing device is configured to execute the synchronization engine that receives as input the artist audio file, the tempo map for the artist audio file, and the data file, and outputs via the graphical user interface the synchronized music lesson for the artist audio file.

28. The system of claim 21, wherein the graphical user interface comprises a tempo control for regulating a tempo of the synchronized music lesson.

29. A method of music synchronization, comprising:
providing an artist audio file;
providing a data file, the data file corresponding to the artist audio file and including data relating to fingering positions for an instrument; and
executing a synchronization engine with a processing device that receives as input the artist audio file and the data file, and outputs via a graphical user interface a synchronized music lesson for the artist audio file.

30. The method of claim 29, comprising receiving as input the artist audio file and generating, with the processing device, a tempo map for the artist audio file.

31. The method of claim 30, comprising receiving as input the artist audio file and the tempo map for the artist audio file, and generating, with the processing device, the data file corresponding to the artist audio file.

32. The method of claim 31, comprising executing the synchronization engine that receives as input the artist audio file, the tempo map for the artist audio file, and the data file corresponding to the artist audio file, and outputs via the graphical user interface the synchronized music lesson for the artist audio file.

33. The method of claim 29, comprising regulating a tempo of the synchronized music lesson via a tempo control of the graphical user interface.

34. A non-transitory computer readable medium storing instructions, wherein execution of the instructions by a processing device causes the processing device to implement a method, comprising:
storing an artist audio file;
storing a data file, the data file corresponding to the artist audio file and including data relating to fingering positions for an instrument; and
executing a synchronization engine with a processing device that receives as input the artist audio file and the data file, and outputs via a graphical user interface a synchronized music lesson for the artist audio file.
